(19) United States
(12) Patent Application Publication
(10) Pub. No.: US 2006/0206507 A1
(43) Pub. Date: Sep. 14, 2006

(54) Hierarchal data management

(76) Inventor: Ziyad M. Dahbour, San Mateo, CA (US)

Correspondence Address: CARR & FERRELL LLP, 2200 GENG ROAD, PALO ALTO, CA, 94303, US

(21) Appl. No.: 11/357,617

(22) Filed: Feb. 16, 2006

Related U.S. Application Data
(60) Provisional application No. 60/653,709, filed on Feb. 16, 2005.

(51) Int. Cl. G06F 7/00

(52) U.S. Cl. 707/100; 707/104.1

(57) ABSTRACT

A hierarchal data management system for a storage device includes an entity relationship discover to generate meta data from a business object, a file manager to create a partition based on the metadata, a data mover to generate a logical partitioning key and to store the logical partitioning key in the metadata for the partition. The file manager includes a data management policy to define a data class and a storage policy to map the data class to the storage device to form a partition table.

### CROSS-REFERENCE TO RELATED APPLICATIONS

The present invention claims priority under 35 USC §119 based on U.S. provisional application Ser. No. 60/653,709 filed on Feb. 16, 2005, the disclosure of which is hereby incorporated herein by reference.

### BACKGROUND

1. Field of the Invention

The present invention relates to data management and databases.

2. Related Art

There are three major vendors in the marketplace that provide data archiving and data sub setting solutions including Outer Bay Technology with the product lines of Live Archive, Instant Generator, Developer Edition, and Encapsulated Archive; Applimation with the product lines of Informia archive and Innformia subset; and Princeton SofTech with the product line of Achive for Servers; and Solix with the product line of ARCHIVEjinni.

These products are not true data management solutions despite the fact that these vendors are claiming that their solutions are providing Information Lifecycle Management. These products are simply data purging and archiving solutions. Data to be archived is physically and logically removed from a source table and moved into another physical table which is called a target archive table. There is no assurance that the target archive table be readily available. The target archive table may reside in the same database as the source table, on a separate database, on the same server or on a separate database on a separate server.

In many instances, the user is no longer able to easily access this archived data or may only have limited access to the data once it has been removed from the source table. Another problem is that access to the archived data is only by read-only mode. There are some instances when it is necessary to write to the data. For example, if a sales order has been archived, then additional information relating to the sales order is not available for creating a return material authorization (RMA) for returning material based on the archived sales order. Instead, the user must learn an alternate method for gaining access to the archive data. The archived information may not be online, and consequently the user would have to wait until the archived information is available. Once information is moved to the target archive table, then upgrades for the source table from the data management application vendors may not be available to upgrade the archived data. Consequently, either the archived data remains not archived, or the archiving vendor is required to upgrade the target archive table manually which may endanger the correctness of the upgraded data. Furthermore, archiving the data requires strict business rules and regulations to be implemented prior to purging the data to the target archive table. Some of these rules are very strict rendering the implementing and archiving solution virtually impractical.

FIG. 1 illustrates how the prior art and existing products solve the hierarchal nature of data in any archiving context. FIG. 1 shows that the inactive data is purged from the source data, and the inactive data is relocated into one or more other physical tables. In FIG. 1, the table XYZ 102 is the table to be purged. More particularly, the data before the year 2003 is placed in the archived data table 106 and the remaining data is kept in the active data table 104. For example, row 1 of table 102 is moved to the active data table 104, and rows 2-4 are moved to the archived data table 106. In the prior art solution, a UNION-ALL view is created to allow access to the active data table 104 and the archive data table 106. However, the attributes of the database views are not 100% compatible with each other which results in significant limitations.

FIG. 4 illustrates an architecture used in the prior art to implement the combined access to the original and archive table. This is accomplished by creating a database view using UNION SQL operations to provide a logical structure of the original table. This solution has numerous limitations such as the attributes of the database views which are not compatible with the original table attributes. These incompatibilities of attributes could result in SQL parsing and execution errors. The use of ROW ID pseudo column of the Union view becomes invalid. This requires a modification to the application code which renders the architecture to be less than totally transparent to existing applications. Additionally, there is a high possibility of negative performance impact on the runtime of the SQL statements referencing the union view since the user application was not designated with the assumptions of the Union view. Furthermore, a separate database schema would have to be created and maintained to implement this architecture, and the user would have to be trained in this architecture and advised as to new methods to access the archived data.

### SUMMARY

Some embodiments of the present invention are configured to provide a data management architecture that allows users to easily manage data growth challenges without losing functionality, imposing overly burdensome restrictions, unnecessarily limiting data availability or sacrificing performance. The architecture of the present invention is transparent to users and sufficiently flexible to meet special user requirements with easy to configure parameters.

In typical embodiments of the present invention, inactive data is managed without requiring the removal or purging of the data from the system. Consequently, the data management is transparent to applications of the user. Users need not be concerned about access to inactive data because this data remains logically available. In the present invention, the data is rearranged into different tiers or partitions so that the data can be effectively managed.

Various embodiments of the present invention include a partitioned data management solution that does not require archiving or purging of data from the system. More particularly, these embodiments include different partitions of data which may be active or inactive data but is available to be updated for new transactions. Additionally, these partitions of data are available to the users for modification and reporting. This advantage is achievable because the HDM (hierarchical data management) architecture may provide a given source table that resides in different partitions as considered by the relational database management system RDBMS as a single table.

The present invention typically has minimal impact to existing performance. The HDM architecture is constructed using a database partition which has native features fully supported by the RDBMS system including the SQL optimizer. Partitions are designed by the RDBMS system to be fully supported and provide full backward compatibility with regular tables at the semantics and syntax level. This results in that applications that were designed and built prior to the introduction as of the partitions will be functional and supported by the RDBMS system.

Various embodiments of the invention are configured to provide transparency for the application code so that the syntax and semantics of existing application code will function properly when accessing data residing in different tiered partitions of the same table.

Various embodiments of the present invention are configured to provide predictable and scalable runtimes for data management operations. This is achieved by the HDM engine operating on data in bulk using data definition language (DDL) at the table partition level instead of the individual record level. The HDM engine uses the meta data available in each database engine to execute the appropriate DDL operations, and consequently, the data base management under the HDM architecture is not linearly proportionate to the amount of data being managed.

Various embodiments of the present invention are configured to provide flexibility to users to determine the criterion to be used to effectively implement the HDM architecture. For example, the HDM architecture can be implemented using liberal business rules which could include in-flight transactions to rearrange the data into tiered storage areas.

Various embodiments of the present invention are configured to maintain the integrity of the system since no data is being physically deleted or removed from the system.

Various embodiments of the present invention include subsetting a copy of the production database as a natural byproduct of the HDM architecture. A copy of the production HDM architecture may be made for testing purposes for example when the entire footprint of the database is not required, creating an image with only active data is a matter of only copying the active data files and off-line dropping the inactive data files.

Various embodiments of the present invention include a system and method for hierarchal data management HDM by rearranging structured data into multiple data classes which are associated to corresponding storage classes while achieving online access to all of the data. Data partitioning may be used to implement the data class concept to allow the large database tables to be subdivided into smaller partitions which are associated with different storage tiers to provide a nearer optimized data management task.

Various embodiments of the present invention are configured to provide a mechanism to manage the growth of structured data within a relational database taking into consideration the data lifecycle, ensuring online data availability, and enforcing data security, stabilizing system performance, minimizing the cost of ownership and maintaining transparency to the users.

The HDM architecture can be implemented on almost any database platforms or enterprise-level application such as ERP to manage data growth or implement data security at the business object level or any other applications without impacting significantly the business process, reports, screens, document workflow, process flow, transactions, future application upgrades, data access or any related customization implemented by the users. The HDM architecture is sometimes implemented on a low level system and, thus, requires little or no change or modification to the existing applications, SQL syntax or SQL semantics. Since the HDM architecture advantageously alters the table type to the partitioned table to implement a version of HDM architecture, the HDM architecture is transparent to maintain the SQL syntax and semantics intact within the HDM architecture. The HDM architecture employs the built-in support within the RDBMS for maintaining full syntax and semantics compatibility between the table type and the partition table type to achieve application code transparency, transact ability and performance stability.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates an active data table and the archived data table, according to various embodiments of the invention;

FIG. 2 illustrates a original table and a table including partitions, according to various embodiments of the invention;

FIG. 3 illustrates a partitioned table and metadata, according to various embodiments of the invention;

FIG. 4 illustrates a union view of the table, according to various embodiments of the invention;

FIG. 5 illustrates the partition table with various users, according to various embodiments of the invention;

FIG. 6 illustrates the partition table on different subsystems, according to various embodiments of the invention;

FIG. 7 illustrates multiple tables linked by a logical partitioning key, according to various embodiments of the invention;

FIG. 8 illustrates the partitioned table and index, according to various embodiments of the invention;

FIG. 9a illustrates different partitioned tables on different disks, according to various embodiments of the invention;

FIG. 9b illustrates a copy of a disk;

FIG. 10 illustrates the partitioned table with compressed partitions;

FIG. 11 illustrates the HDM process flow, according to various embodiments of the invention;

FIG. 12 illustrates the access layer method, according to various embodiments of the invention;

FIG. 13 illustrates the data management policy, according to various embodiments of the invention;

FIG. 14 illustrates the storage policy process, according to various embodiments of the invention;

FIG. 15 illustrates the database subset method, according to various embodiments of the invention;

FIG. 16 illustrates the data mover method, according to various embodiments of the invention;

FIG. 17 illustrates the logical partitioning key method, according to various embodiments of the invention;

FIG. 18 illustrates the entity relationship discoverer, according to various embodiments of the invention;

FIG. 19 illustrates the partition mover method, according to various embodiments of the invention;

FIG. 20 illustrates the database reorganization method, according to various embodiments of the invention;

FIG. 21 illustrates the HDM system architecture, according to various embodiments of the invention;

FIG. 22 illustrates an exemplary computer system, according to various embodiments of the invention; and

FIG. 23 illustrates a block diagram of the exemplary computer system, according to various embodiments of the invention.

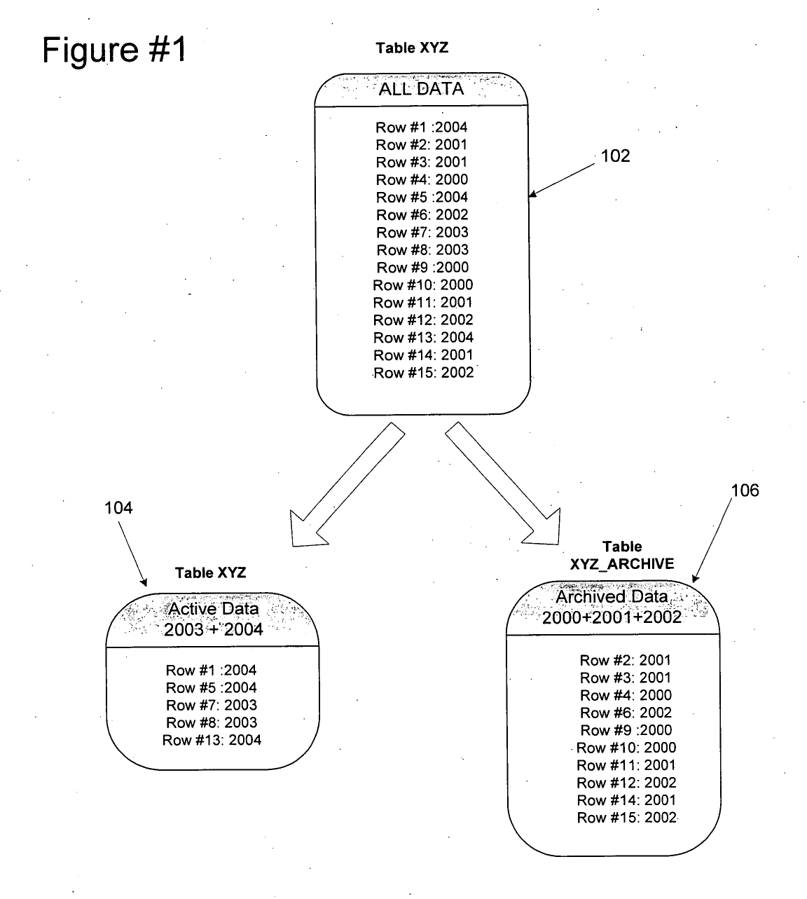

### DETAILED DESCRIPTION

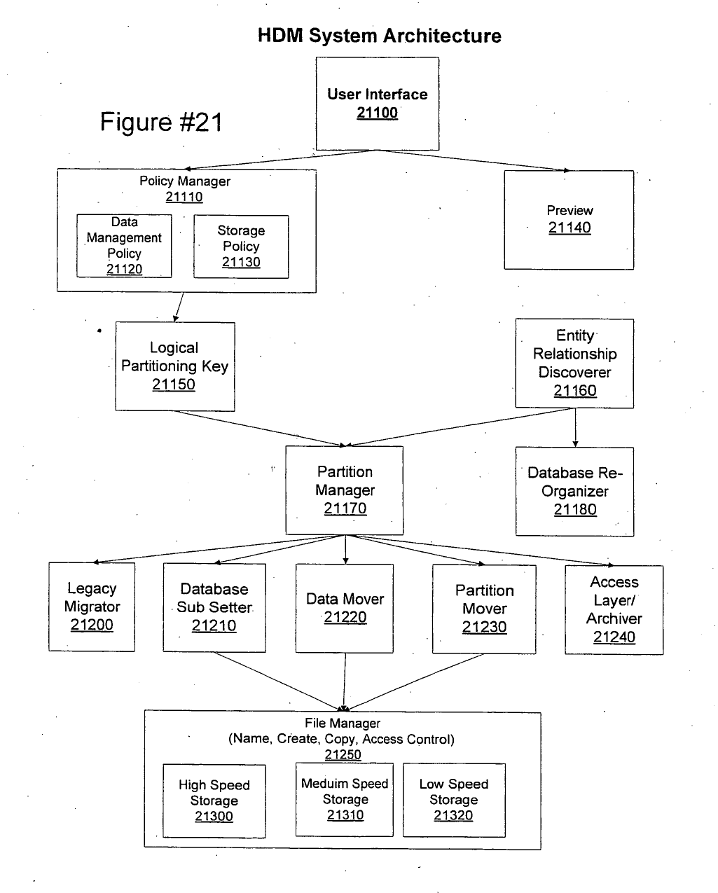

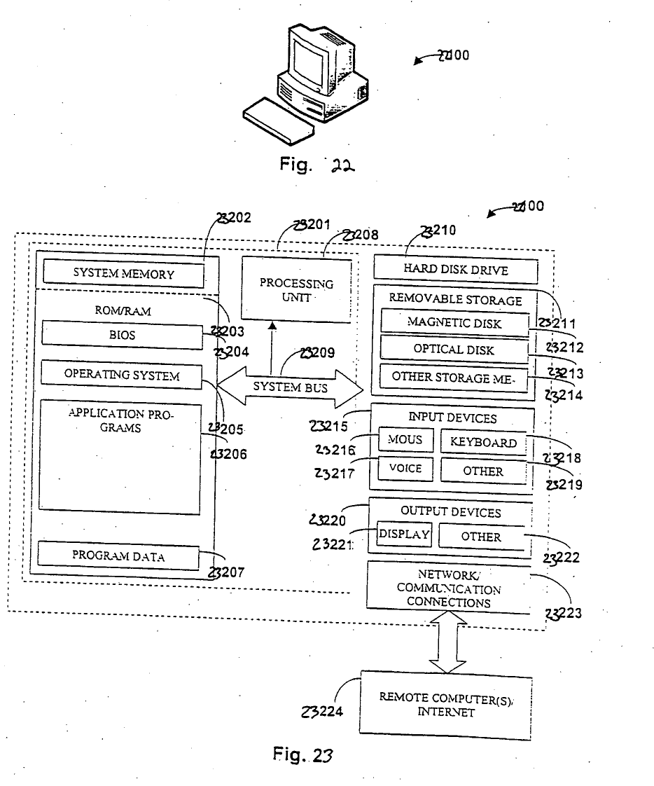

FIG. 22 illustrates an exemplary computer system 22100 that may be used to execute the data base the invention and FIG. 23 shows a block diagram of the exemplary computer system 100 shown in FIG. 23, including; output devices 23220, such as, but not limited to, a display 23221, and other output devices 23222; input devices 23215 such as, but not limited to, a mouse 23216, a voice input device 23217, a keyboard 23218 and other input devices 23219; removable storage 23211 that may be used to store the data base of the present invention or store data for use with the invention, or otherwise interact with the invention, such as, but not limited to the following storage devices, magnetic disk storage 23212, optical storage 23213 and other storage 23214; a hard drive 23210 that may be used to store and retrieve software programs incorporating code that aids or executes the invention or stores data for use with the invention, or otherwise interacts with the invention; and typical system components, such as those within dashed line 23201, including but not limited to system memory 23202, which typically contains BIOS (Basic Input Output System) 23204, RAM (Random Access Memory) and ROM (Read Only Memory) 23203, an operating system 23205, application programs 23206, program data 23207, a processing unit 23208, system bus 23209, and network and or communications connections 23223 to remote computers and or the Internet 23224.

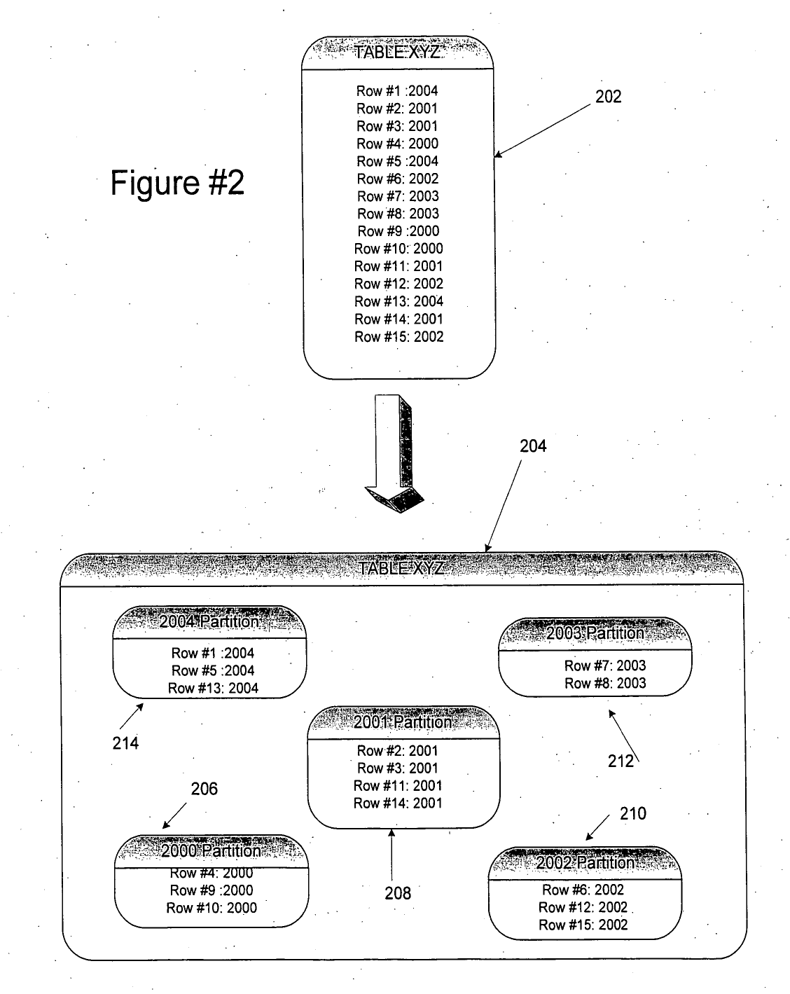

FIG. 2 illustrates by an example of how the HDM architecture of the present invention can rearrange the data into a single table having multiple partitions. In this instance, the data is grouped into partitions based upon the age of the data in the system. In this example, the data for each year is separated into its own partition. In FIG. 2, the combined table XYZ 202 or source is shown having rows corresponding to different years. The HDM architecture examines each row of the combined table XYZ 202 and separates the data by year and places the data in a partition based upon the year. Partition table XYZ 204 includes a first partition 206 including rows 4, 9 and 10 that correspond to data from year 2000. Likewise, second partition 208 includes rows 2, 3, 11 and 14 that correspond to the data from the year 2001. A third partition 210 corresponds to data for the year 2002, a fourth partition 212 corresponds to data for the year 2003, and a fifth partition 214 corresponds to data for the year 2004. There are many other ways of partitioning the data, for example the data could be partition based upon some attribute or characteristic such as a vendor. As a result of this partitioning, the HDM architecture can maintain the integrity of the original table 202 and avoids the need for creating a view to access the current and archived data. Since the attributes of the original table 202 are compatible with the partition table 204, the integrity of the table structure is maintained, avoiding a significant number of limitations discussed above with respect to the prior art.

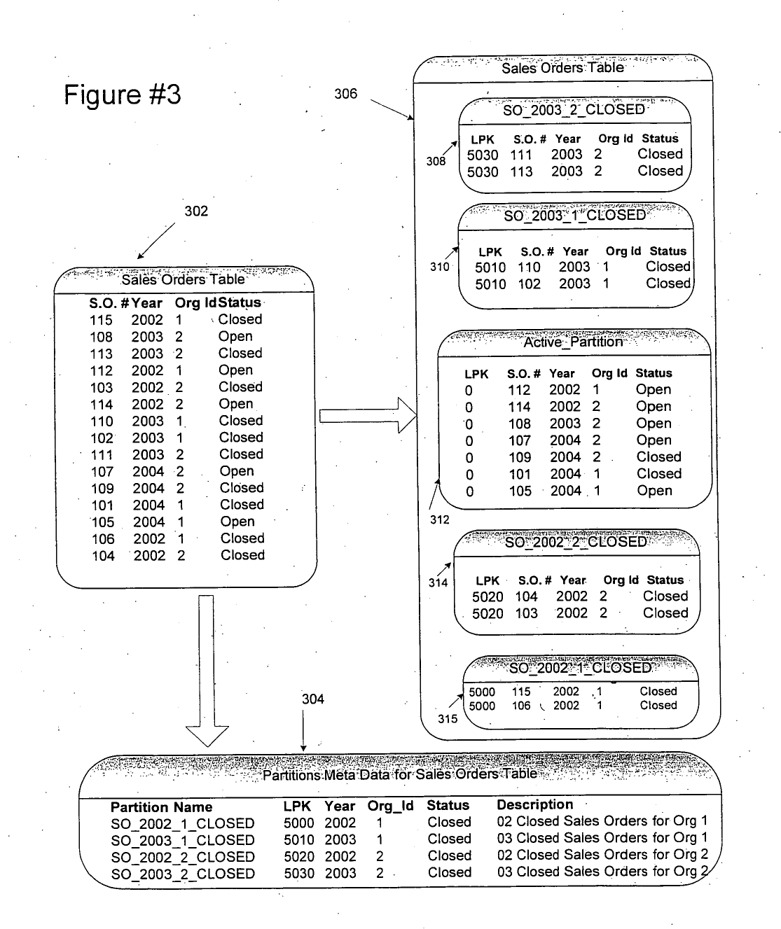

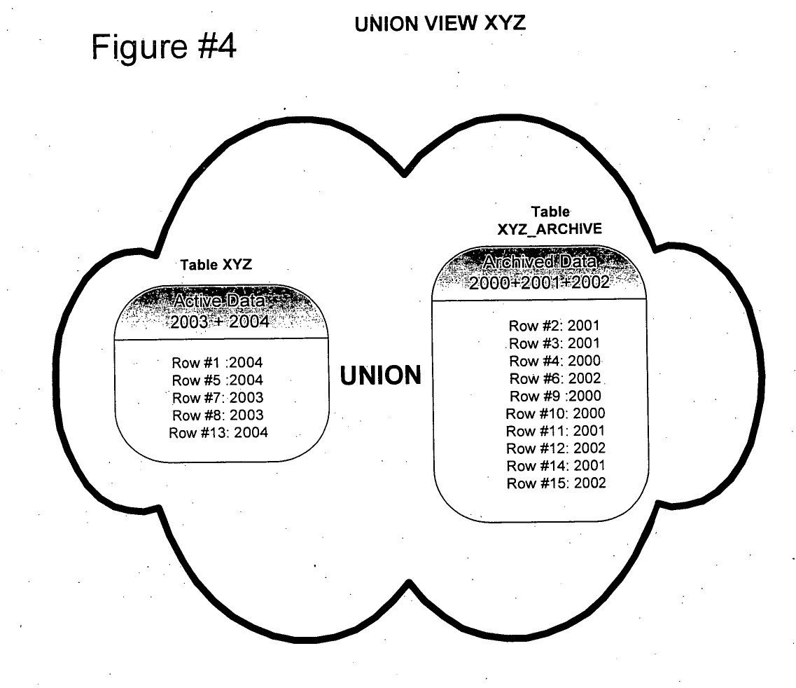

FIG. 3 illustrates another example of the HDM architecture implementing partitioning of the original table 302 into partition table 306 which is based upon complex conditions and multiple columns in one or more tables. The HDM architecture generates a partition meta data table 304 which includes a logical partitioning key (LPK) in order to define which partition the HDM architecture is to transfer the data into. For example, the sales order number 115 from the original table 302 has a logical partitioning key of 5000 to indicate that the data across the different tables that makes up this particular business object (the sales order) should be transferred to partition 315. In a similar fashion, the sales order number 108, within original table 302, has a logical partitioning key of 0 to indicate that partition 312 is the default partition that will hold all new sales orders until these sales orders become eligible to be moved to separate partition. The default partition is used to eliminate any obstruction to the application's normal functional flow. In this fashion, all of the data is evaluated by the HDM architecture by running a program during low activities to minimize the impact to application's critical process flow. In general, the appropriate logical partitioning key corresponding to the data is obtained, and the data is transferred to the appropriate partition in accordance with the logical partitioning key. In FIG. 3, the data partitioning is based upon the organization, fiscal year of the sales order, and status. This figure additionally shows the generated meta data is created and is maintained by the HDM engine to associate the partition with the actual data content and the logical partitioning key.

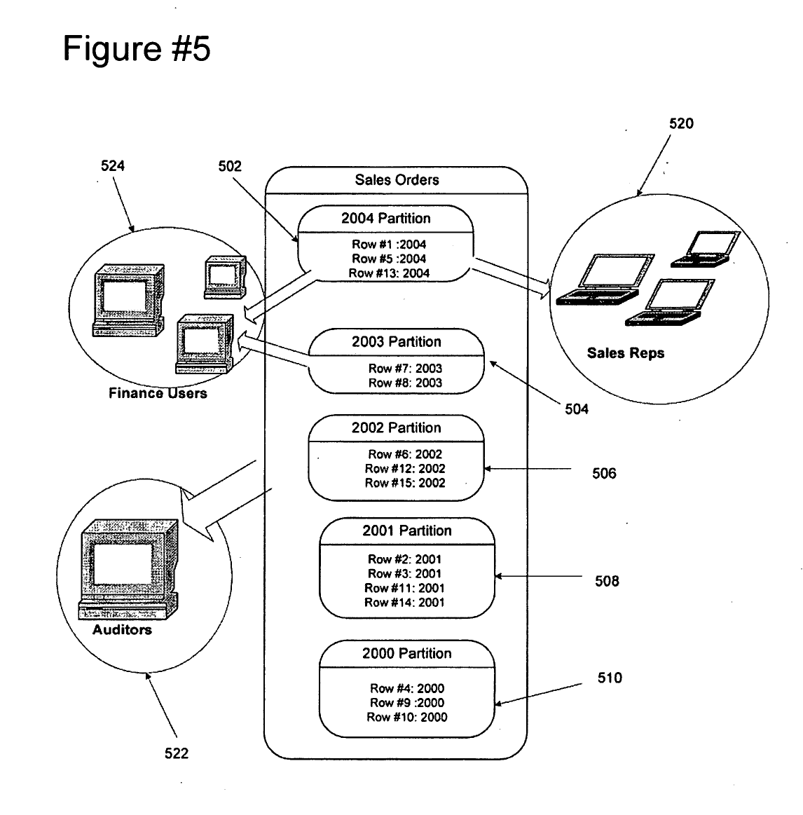

FIG. 5 illustrates the ‘dynamic archiving’ of the HDM architecture, according to various embodiments of the invention. The HDM architecture can be used to achieve data archiving without purging or relocating data from the source table. This aspect can be achieved by making inactive data invisible to the user by dynamically filtering out or making unavailable unneeded partitions to the user. Consequently, modifying the access to the data for the user can be achieved by the modification of appropriate filters in the user's session, avoiding the need for actual moving the data. In addition, different users can dynamically control the set or number of partitions that these users would like to access without impacting the set or number of partitions available to other users.

FIG. 5 illustrates various users including sales reps 520, auditors 522 and finance users 524. Additionally, FIG. 5 illustrates various partitions including the 2004 partition 502, the 2003 partition 504, the 2002 partition 506, the 2001 partition 508 and the 2000 partition 510. The profile of the sales reps 520 is set up to view the sales order data from the 2004 partition 502. In contrast, the profile of the finance users 524 is set up to access the sales order data from the 2004 partition 502 and the 2003 partition 504. The profile of the auditors 522 is set up to access the sales order data from all the partitions 502, 504, 506, 508, 510. Instead of archiving data from the source table, the present invention allows data to be placed in a predetermined set of partitions and the profile of different user's groups can be selectively set up concurrently so that different user's groups can view different ranges of partitions without impacting each others.

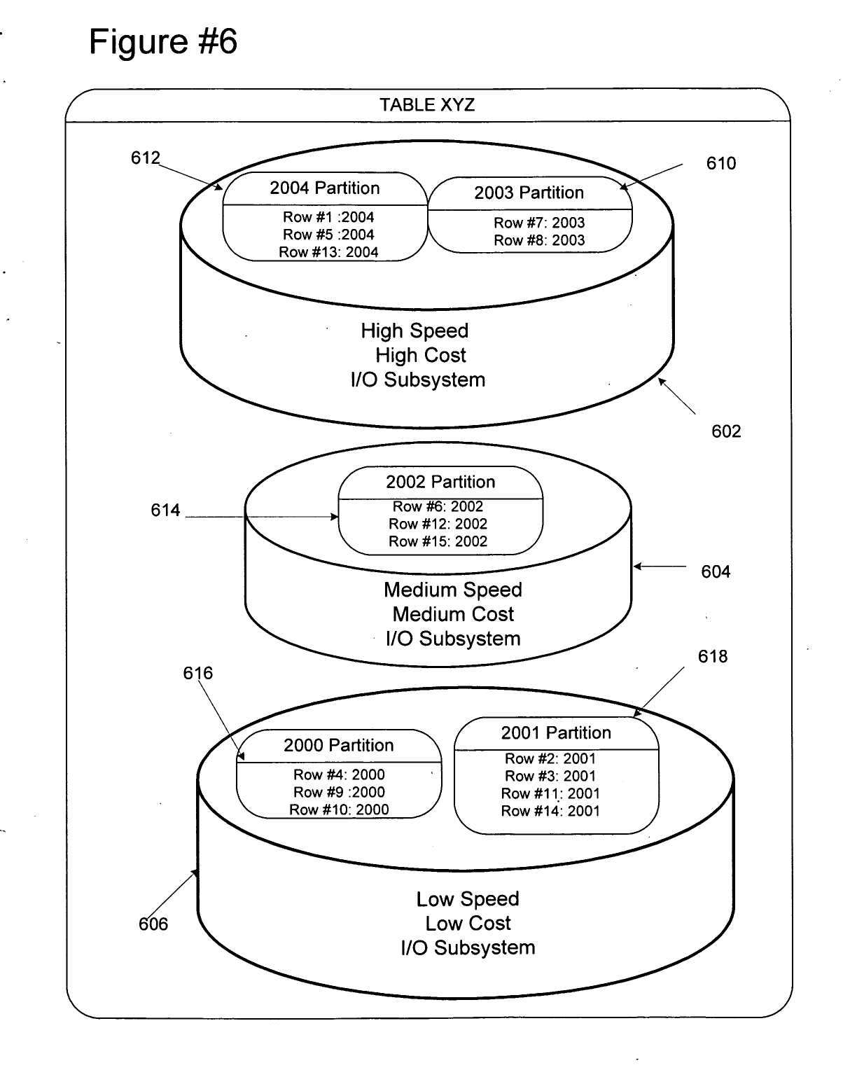

FIG. 6 illustrates another dynamic aspect, according to various embodiments of the invention. FIG. 6 demonstrates that the HDM architecture has the ability to manage data at the physical database level. More particularly, the predetermined partitions can be designated to be placed on a predetermined I/o subsystem. Based on the configuration of the user, a new partition or a group of related partitions may be created in a predetermined file that is in the appropriate storage class or classes that has been predefined by the administrator. Next, the data mover of the HDM architecture relocates the rows related to a predetermined business object to the predetermined partition. Shown as an example in FIG. 6, the table XYZ includes partitions 610, 612, 614, 616, 618 configured on a high-speed, high-cost, I/O subsystem 602, a medium speed, medium cost, I/O subsystem 604 and a low speed, low cost, I/O subsystem 606. The 2003 partition 610 is positioned on the high-speed, high-cost, I/O subsystem 602 because the data in the 2003 partition 610 may be desired to be accessed by a large number of users and accessed frequently. Over time, the need to access 2003 partition 610 may decrease, and the partition 610 could be moved to the medium speed, medium cost I/O subsystem 604. If a new row should be added to the 2004 partition 612, the data mover will move the new row to the partition 612. In this example, the smaller percentage of recent active data can be placed on the high performance, high-cost I/O subsystem 602; the less active data can be placed on the medium performance, medium speed I/O subsystem 604; the inactive data which is usually the higher percentage of data distribution can be placed on the low speed, low cost I/O subsystem 606 which is generally a more affordable I/O subsystem. This aspect of the HDM architecture allows users to obtain near optimal results based on the ability to manage ever increasing data growth challenges without losing features or impacting the business processes of the users of their existing enterprise systems.

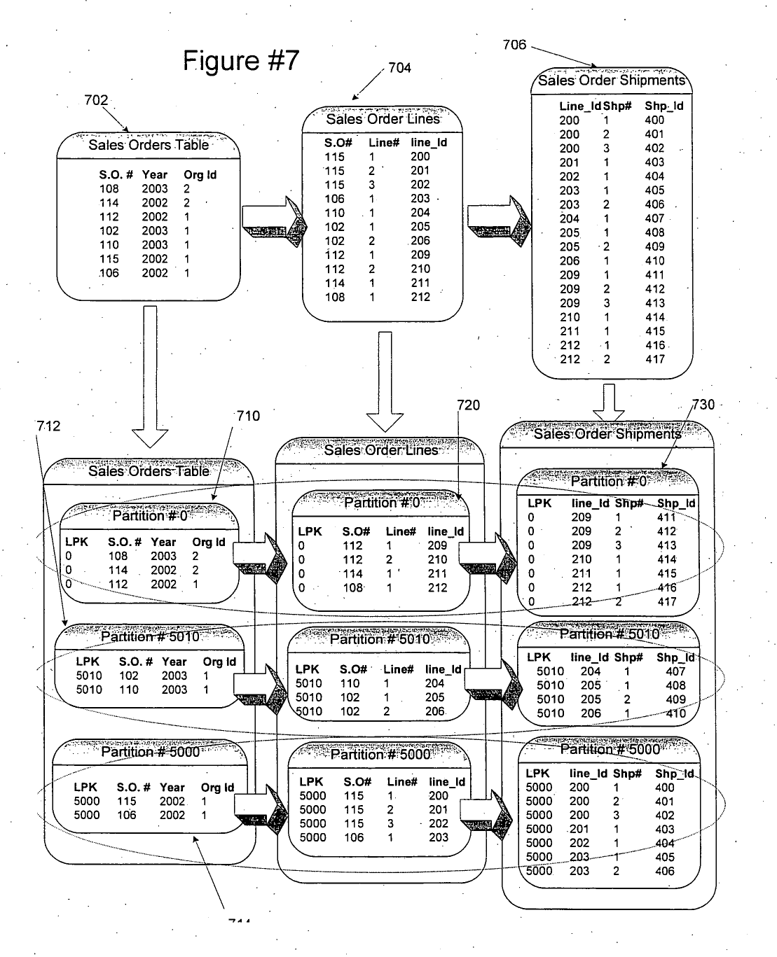

FIG. 7 illustrates an aspect of the HDM architecture to maintain the referential integrity of related tables at the partition level in accordance with the teachings of various embodiment of the present invention. This aspect is important to the business objects, for example a sales order, which includes one or more records in multi-related tables. FIG. 7 illustrates a sales order table 702, a sales order lines table 704 and a sales order shipments table 706. Each of the tables 702, 704, 706 may include different information concerning the same sales order. For example, sales order table 702 includes data for the sales order 108 as illustrated in the first row of the sales orders table 702, and data for sales order 108 is illustrated in the last row of the sales order lines table 704. Furthermore, when shipment data is entered for the sales order 108, this data will be placed into the default partition of sales order shipments table 706. FIG. 7 additionally illustrates that each of the tables 702, 704, 706 have partitions based upon the same logical partitioning key (LPK) consistently namely, 0, 5010, and 5000. The sales order table 702 includes sales order 108, 114, 112 for the 0 partition (the default partition) 710, sales orders 102, 110 for the 5010 partition 712 and sales orders 115, 116 for the 5000 partition 714. FIG. 7 illustrates horizontal partitioning in which related tables have been partitioned with the same logical partitioning key (LPK). As an example of this horizontal partitioning, partition 710 has the same logical partitioning key as partition 720 and partition 730. Each table 702, 704, 706 should have a partition having the same logical partitioning key (LPK). Using this feature allows the HDM architecture to utilize granular open data management features at the partition level provided natively by the RDBMS to achieve high-performance runtime.

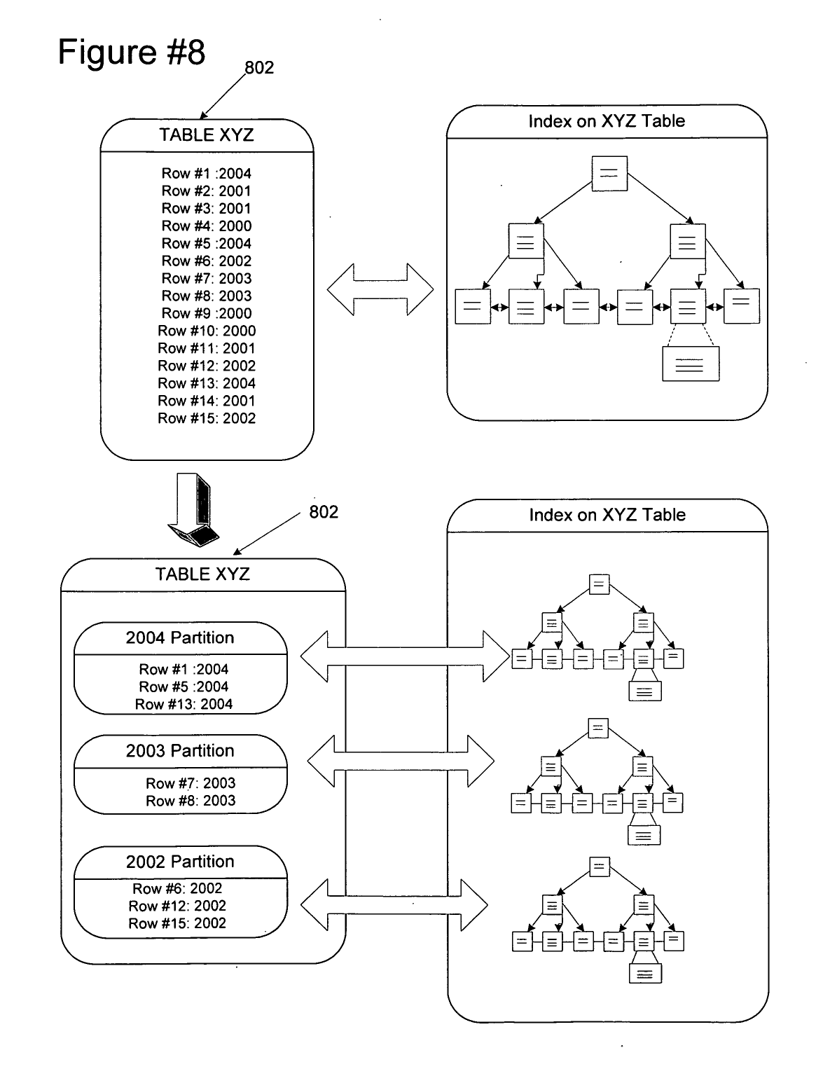

FIG. 8 illustrates the management of the indexes within the HDM architecture in accordance with the teachings of various embodiments of the present invention. FIG. 8 shows that local partitioned indexes are created and maintained for partitioned tables in order to enhance the performance of bulk data management operations. These features allow the HDM engine of the HDM architecture to drop, move, off-line, rebuild, and other operations on a given partition and its associated index partition without impacting other partitions within the same table 802. This improves system availability and results in managing large tables much easier. The partitioned indexes include the LPK columns as either a leading, or trailing column in the existing structure to eliminate the impact on execution plans of the SQL optimizer.

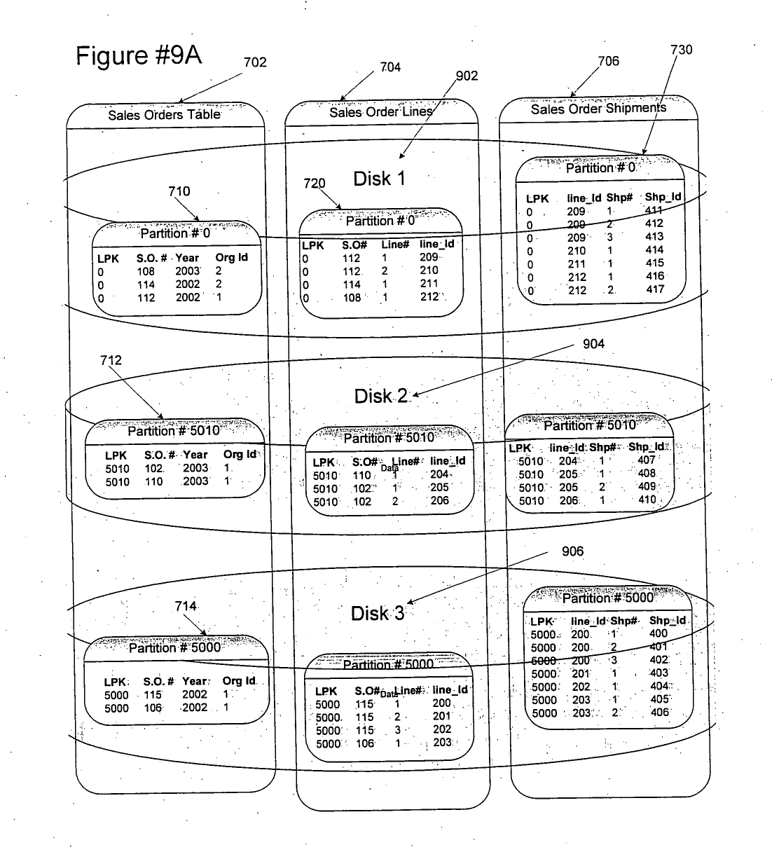

FIGS. 9a and 9b illustrate the HDM architecture being used to create a reduced copy of a database in accordance with the teachings of various embodiments of the present invention. A reduced copy of the databases is created by copying the partitions that hold active data only. Alternatively, in addition to holding only active data, the reduced copy of the database could include the active partitions and a selected portion of the inactive partitions which could be chosen in accordance with the configuration parameters of the user. In this way, partitions that hold unneeded data are not included with the reduced copy of the original database. Typically, inactive data accounts for the majority of the space taken by the original database so that the reduced copy may be significantly smaller than the original database. This aspect provides a fast way to clone the original database. The reduced in size database copy can be created by directly copying the required set of data files from the production database that are mapped to the user input parameter. This eliminates the need to create a complete copy of the production database to be able to create the reduced in size copy. The reduced copy of the original database can be used in a development or a testing environment in which access to the entire footprint of the original database is not required. This aspect can eliminate the need for additional temporary storage.

FIG. 9a illustrates the sales orders table 702, the sales order lines table 704 and the sales order shipments table 706 being positioned on three separate disks 902, 904, 906. Disk 902 includes a horizontal partition with a default logical partitioning key of 0. More particularly, disk 902 includes partition 710 of the sales order table 702, partition 720 of the sales order lines table 704 and partition 730 of the sales order shipments table 706. The disk 904 and disk 906 each include a partition from the sales order table 702, the sales order lines table 704 and the sales order shipments table 706. It is within the scope of the invention to place multiple partitions on a single disk.

FIG. 9b illustrates a copy 1002 of disk 902 including partition 710 for the sales order table 702, partition 720 for the sales order lines table 704 and the partition 730 for the sales order shipments table 706. This reduced in size database contains complete and consistent subset of sales orders.

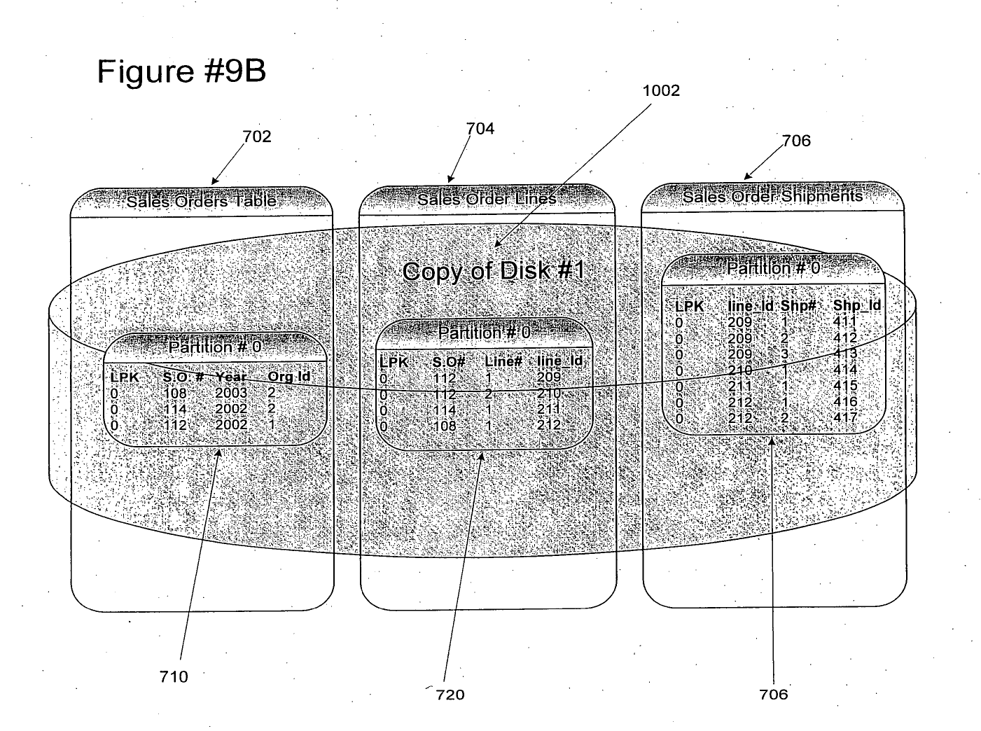

FIG. 10 illustrates the HDM architecture compressing selective partitions and their corresponding indexes of older data to further improve space utilization in accordance with the teachings of various embodiments of the present invention. This data compression may add overhead whenever the compressed data is accessed; however, the HDM architecture provides a trade-off between space/speed by enabling that the active data be maintained in an uncompressed format in order to maintain a high performance while this data is being accessed while providing space utilization of older data which is not accessed as frequently. The users have the option to configur the system to force the compression feature.

FIG. 10 illustrates the XYZ table 204 including the 2004 partition 214 and the 2003 partition 212, both of which are not compressed. In contrast, 2000 partition 1006, 2001 partition 1008 and 2002 partition 1010 have been compressed. As a result, the XYZ table 204 uses less space and is the same table shown in FIG. 2. However, access to partitions 1006, 1008, and 1010 have greater overhead. The user has the option to compress the partitioned indexes of the corresponding partitions.

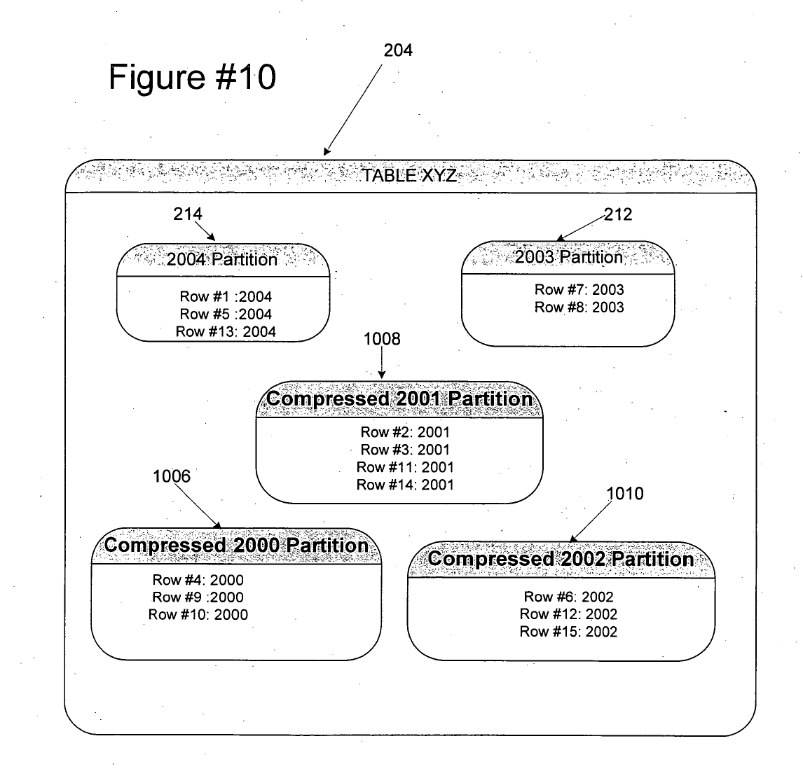

FIG. 11 illustrates the process flow of the HDM architecture at runtime in accordance with the teachings of the present invention. The process begins with step 11100 with the user running the preview process to obtain preview data distribution to see current data growth and the potential impact of actions from the user so that the user can make the correct decision of the use of the particular application module and the type of business criteria. In step 11110, the data management criterion is defined, and in step 11120 the criterion of the user is evaluated in accordance with the data management criterion so that the data management policy is not violated. If the data management policy is violated, in step 11140, the process flow is stopped, and an error message is generated. If the data management policy is not violated, in step 11150, the logical partitioning key is defined, and in step 11160 the data files and table spaces are created in accordance based on the storage policy 11170 for the tables related to the application module to be processed. In step 11180, new partitions are created in accordance with storage policy 11190, and in step 11200, eligible data based on data management policy 11130 and after applying the rules and constraints from 11210, is moved from source partitions to target partitions and tagged with an appropriate logical partition key. In step 11220, the user has the option to reorganize impacted tables and indexes in accordance with storage policy 11230 to reclaim a free space resulting from the data move.

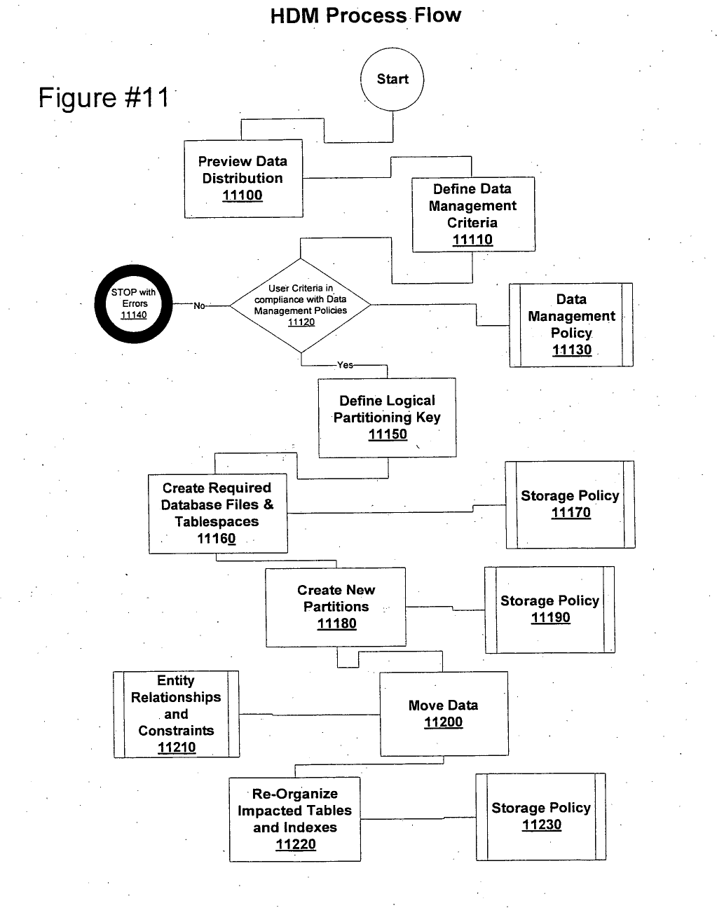

FIG. 12 illustrates the process flow for users and system administrators in order to configure data access in accordance with the teachings of various embodiments of the present invention. This process flow allows administrators to select different access options for their users to use the data concurrently without moving the data physically. More particularly, FIG. 12 illustrates the process flow in order to configure the access to the data as described with FIG. 5. Different users can access different partitions. For example, sales representative users may have access only to sales order created for the last year. A sales order management team may have access to sales orders from the last two years. Auditors may have access to sales orders from the last seven years. FIG. 12 illustrates the steps for achieving an access layer method. In step 12100, the business requirements are determined to derive which users should have access to which partitions. In step 12110, a data access window is defined based upon the business requirements. Next in step 12120, the dynamic access views for the partitions are configured by the system, and in step 12130 the HDM metadata is generated. An example of this metadata for the sales orders table is shown in FIG. 3 as element 304, and other forms of metadata are within the scope of the present invention.

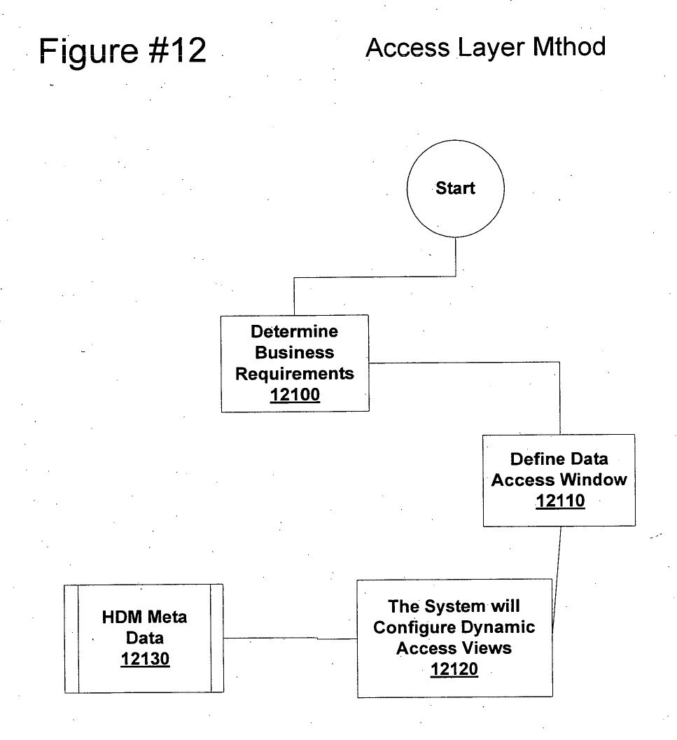

FIG. 13 illustrates a data management policy method in which the users define the data classes which had been set to comply with the needs of the users in accordance with the teachings of various embodiments of the present invention. For example, the users can define active transactions as those transactions that were entered into during the last year. Alternatively, the users could define active transactions as transactions in that were entered into during the last two years or could define the active transactions as transactions that were entered during the last three years.

FIG. 13 illustrates that after the start, the data management policy defines business rules for data classes, for example active, less active or historical in step 13110. In step 13110, the data classes are mapped to storage classes, and in step 13120, the validation rules to prevent erroneous operation are defined. The data migration rules between data classes are defined in step 13130, and in step 13140 the data management policy defines data class attributes as, for example, read-only, security access and protection. The system provides auditing of modifications to data that has not been marked as read-only, and also provides secured access at the business object level.

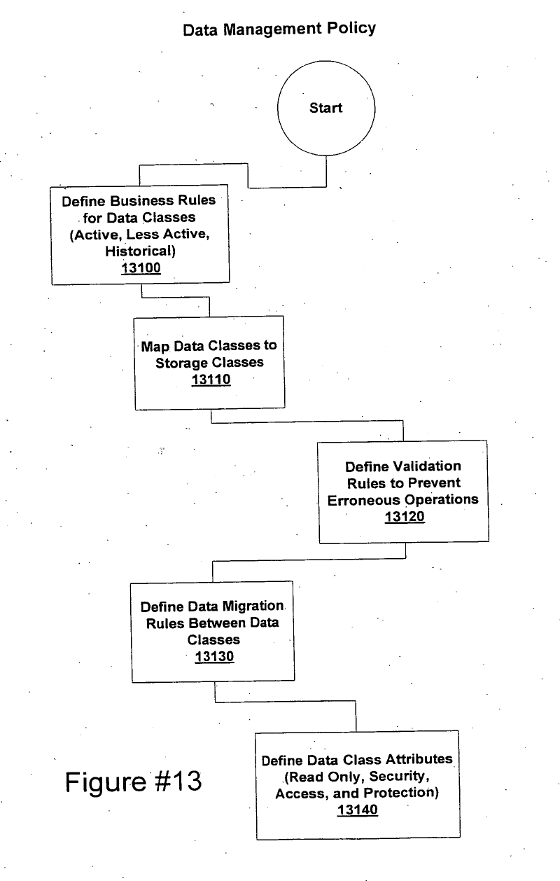

FIG. 14 illustrates the control of the storage policy used by the HDM architecture to control the attributes which are related to data storage in accordance with the teachings of various embodiments of the present invention. The administrator defines different storage classes so that they can be mapped to the data classes area defined by the data management policy. The storage policy is used to define data file information such as file names, directory names, maximum file size, minimum file size and file naming conventions. Additionally, table space information is also managed in the storage policy such as table space name, number of files per table space, storage class and storage parameters for table spaces. The storage policy also stores information related to rebuilding or reorganizing tables and indexes that could be impacted by the data management operation.

FIG. 14 illustrates that the Hieratical storage systems are defined in step 14100, and in step 14110, the attributes of the data files are defined. In step 14120, the attributes of the table space are defined, and in step 14130 the attributes of the partitions are defined. In step 14140, the data management criterion is mapped to storage, and in step 14150, the criterion to reorganize database objects is defined. A list of data base objects is generated in step 14160, and individual database objects are rebuilt in step 14170.

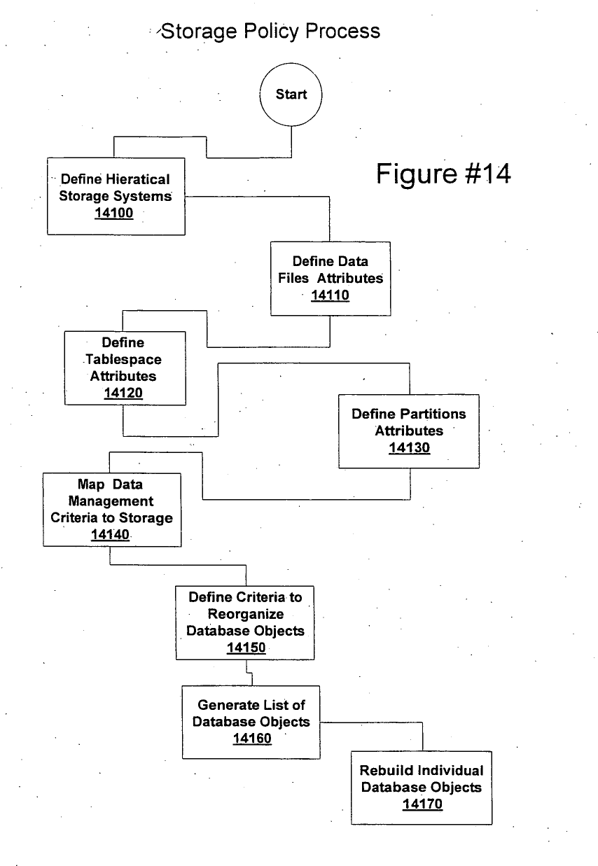

FIG. 15 illustrates the steps of the database sub-setter which could be used to create copies of a portion of the database which would be of a reduced size, leveraging the physical layout of the partitions in the production database in accordance with the teachings of various embodiments of the present invention. The sub-setter uses the business criteria which has been specified by the user to derive a list of partitions to be copied. Once the list of desired partitions to be copied is defined, the list of table spaces and data files needed to create the copy of the database into a target database can be determined. In order to save time and space, only the list of data files that have been identified in accordance with the parameters defined by the user will be copied into the target database. In some instances, the list of identified data files may be a small subset of the original database and consequently less time is required to prepare the target database. After the new database is constructed, the table spaces that contain unnecessary data can be deleted from the database dictionary of the target database. The new target database is then ready for operation.

In FIG. 15 and in step 15100, the business requirements for the data to keep are defined, and in step 15110, a list of partitions to be copied is determined. In step 15120, the data files which are required are determined based upon the list of partitions to be copied; in step 15130, the data files which are required to support the partitions to be copied are copied. Next, in step 15140 the list of data files that are no longer needed, and hence have not been copied, but are still being referenced in the database dictionary, are removed from the database dictionary, and in step 15150 the database is activated for use.

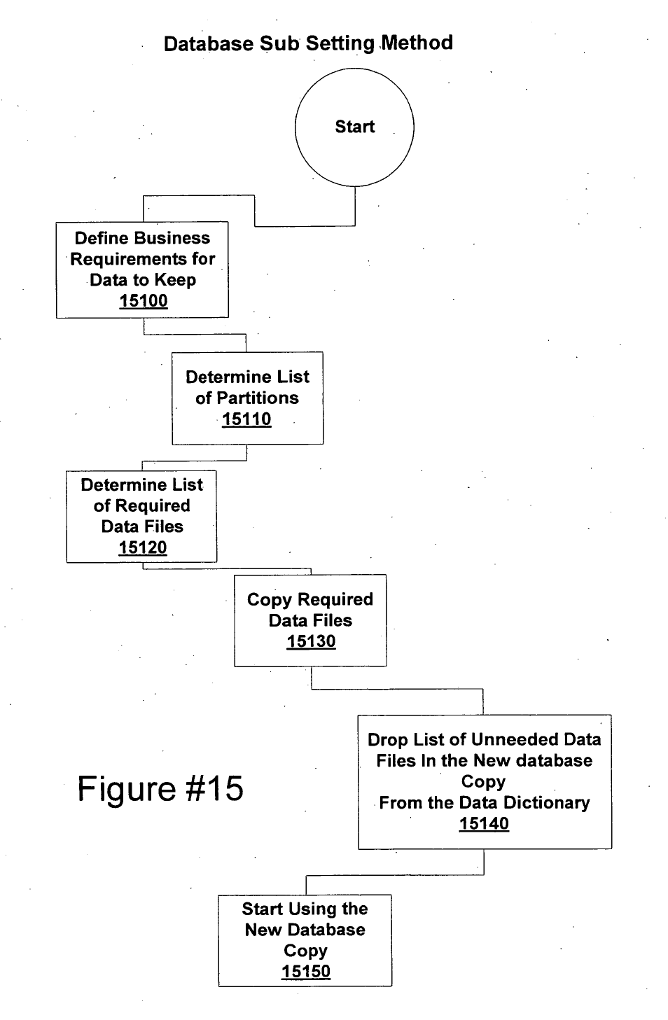

FIG. 16 illustrates the process flow for the data mover of the HDM architecture in accordance with the teachings of various embodiments of the present invention. The data mover is used when managing data for the first time. The data mover moves data from the original partition to a new target partition. Before moving a data from the original partition, data base files and table spaces are created based upon the data storage configurations if the required data files and data spaces to not already exist. Next, the partitions are created according to the storage policy configurations, and the data is next moved into the new target partition. Once the data has been moved into the new target partition, the users have an option to store an encrypted value for every record in order to provide security so that the data has not been altered from its original incarnation. The meta data tables of the HDM architecture are updated to reflect the new set of partitions that have been created and the attributes of the partitions.

FIG. 16 illustrates the operation of the data mover in accordance with the teachings of the present invention. After the operation of the data mover has started, table spaces and data files in the target storage tier are created if needed in step 16150. In step 16160, partitions in the target storage tier are created, and in step 16170 the data mover moves data to the target partition. The metadata of the HDM architecture is updated in step 16180. Encryption values for the new partitions are generated and stored if needed in step 16190.

The HDM architecture uses the logical partitioning key (LPK) which is constructed for each application module and stored in the metadata of the HDM architecture. Table partitioning in the database may be implemented based on values in a single column in the table or based on values of multiple columns in one or more tables. It is conceivable that a value for a given LPK be based on multiple business conditions, constraints and rules that provides a practical method of managing business objects. Furthermore, there may be multiple tables used in the database to model the business object. The present invention advantageously uses one partition key for maintaining the consistency of data at the partition level.

The logical partitioning key may be added as a numeric column in the metadata corresponding to a particular business subject and is used as the partitioning key for the business object. The parameter or criterion of the user is additionally stored in the metadata of the HDM architecture for each application module, and new values of the logical partitioning key are created and associated with these set of parameters. A new partition is created corresponding to every table related to the business object. As shown in FIG. 3, every row of the table corresponding business object may include this new logical partition key. Consequently, the metadata of the HDM architecture is updated to reflect the association of the newly created partition and the newly created logical partitioning key.

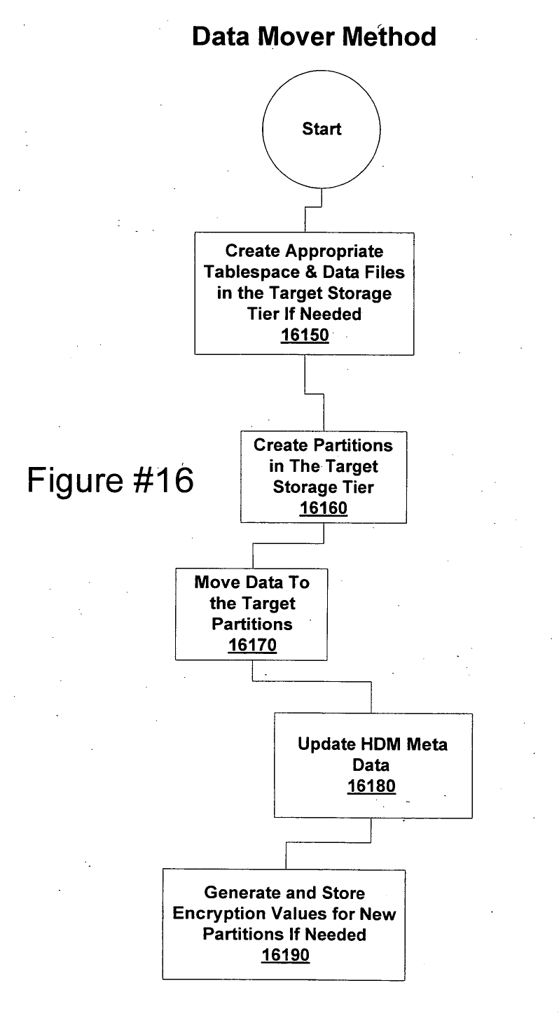

FIG. 17 illustrates that the business criteria for data management for each business object is defined in step 17100, and in step 17110, the business criteria is stored into the metadata of the HDM architecture, according to various embodiments of the invention. In step 17120, the list of tables to be mapped to the business object is determined, and then in step 17130, the new logical partitioning key (LPK) column is added to all tables for such business objects. The metadata for the HDM architecture is generated and stored for every additional business criteria instituted in step 17140, and a new partition for all business objects tables for the same logical partitioning key is created in step 17150. In step 17160, the metadata for the HDM architecture for the newly created partitions with the new logical partitioning key is updated, and the data for the target partition is moved into the new target partition in step 17170. Furthermore, in typical embodiments, the method of which the data is moved is by using an update operation instead of delete-then-insert. This guarantees the accuracy of the system at all times since there doesn't exist a time window or a race condition where the data is absent. The update operation also synchronizes multiple concurrent processes to insure the application correctness, integrity, and accuracy at all times.

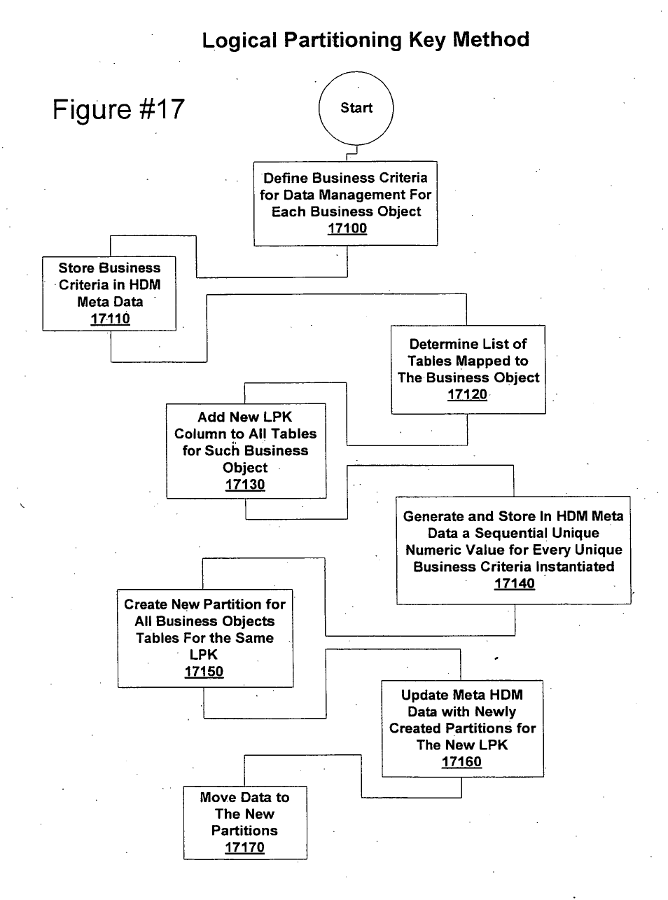

FIG. 18 illustrates the steps by which the HDM architecture discovers entity relationships in order to identify list of related tables to model a business object in accordance with the teachings of various embodiments of the present invention. The steps may be taken during the time that the business object is built. The results of the entity relationship determining process are stored in the metadata of the HDM architecture for use by the HDM engine at a later time to implement the data management policy. If the entity relationships are defined in the database dictionary, the list of related tables may be derived directly from the database directory or dictionary. However, many complex applications do not define entity relationships in the database dictionary. In this case, the tool will use unique indexes and compare them to non-unique indexes on other tables in an attempt to derive parent-child relationships. In addition, the method of matching column names or partial column names in different tables is used to derive possible parent-child relationships. In other cases, the entity relationships are actually embedded within the application code. Consequently, the system will provide the users with frame work to define table relationships manually.

The HDM engine uses constraints and conditions to implement the partitions of the data management in addition to the above-mentioned entity relationships. In some embodiments, these constraints and conditions may be stored in the metadata of the HDM architecture. In some embodiments special drivers are configured for the application modules depending on the complexity of the application module.

FIG. 18 illustrates the steps of the entity relationship discoverer which starts in step 18100 in which the entity relationship discoverer determines if the primary-key and the foreign-key are registered in the database. If the primary-key and the foreign-key are not registered in the database, then the entity relationship discoverer in step 18110 determines if the application source code is available. If the application source code is available, then the entity relationship discoverer derives the entity relationships from the source code in step 18120. If the application source code is not available, entity relationships are derived from reverse engineering of the application source code in step 18140 or the entity relationships are derived using fuzzy logic including matching column names in step 18150. From both of the steps, the application constraints are defined in step 18160.

If the entity relationship discoverer determines that the primary-key and foreign-key are registered in the database, then the entity relationships are derived from the data dictionary in step 18130, and the application constraints are defined if they exist in step 18160. The entity relationships and the constraints are then stored in the metadata of the HDM architecture in step 18170.

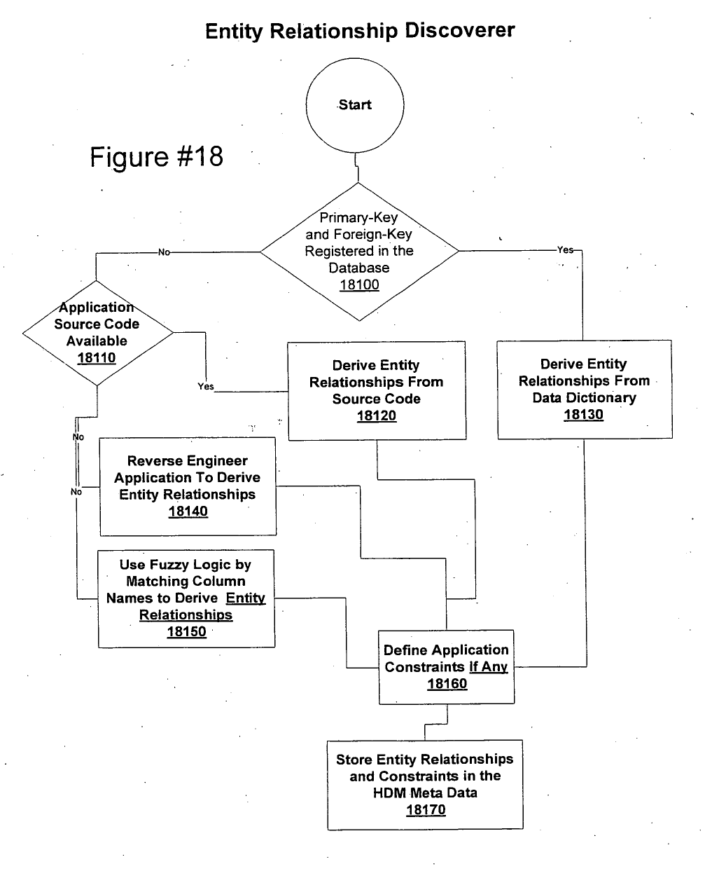

FIG. 19 illustrates the operation of the partition mover as a series of steps in conjunction with the HDM architecture in accordance with the teachings of various embodiments of the invention.

The partition mover operates when a predetermined set of partitions are flagged or identified by the storage policy to be moved to a different storage tier when sufficient time has elapsed since the creation of the partitions in the current storage tier. Correspondingly, the associated data files and table spaces are created based on the storage policy configurations. The partitions and their corresponding indices may be moved using high-speed bulk data operations. Subsequently, the metadata of the HDM architecture is updated.

FIG. 19 illustrates that after the operation of the partition mover has started, the existing partitions are checked for compliance against the storage policy in step 19100. If all of the partitions are in compliance, then the operation of the partition mover stops in step 19110. If a partition is not in compliance with the storage policy, then there is a need to migrate that partition to a different storage class. In step 19120, table space and data files are created in the target storage tier. Next, in step 19130, the partition is moved to the new storage tier. In the last step 19140, the metadata of the HDM architecture is updated.

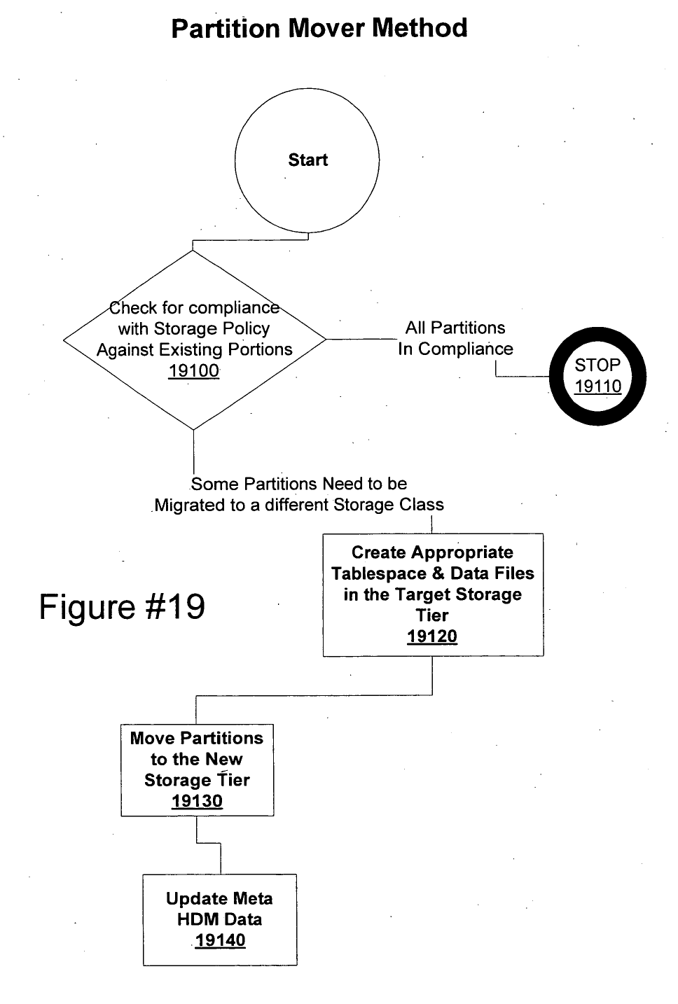

FIG. 20 illustrates the operation of the data reorganization method of the HDM architecture in accordance with the teachings of the present invention. The data reorganization occurs after the data has been redistributed from the original partition which held the data when it was originally created. The data reorganization identifies a list of database objects such as tables and indexes which have been fragmented as a result of the data movement. The data reorganization rebuilds and defrags the identified objects so that space utilization and performance can be improved. The storage policy controls the frequency of operation and parameters of the data reorganizer.

FIG. 20 illustrates the operation of the database reorganizer in accordance with the teachings of various embodiments of the present invention. After the start of the operation of the data base reorganizer criterion is derived to reorganize the database objects in step 20100. The data based reorganizer criterion is based on the storage policy 20110. In step 20120, a list of database objects is generated based upon the metadata 20130 of the HDM architecture, and in step 20140 the individual database objects including tables and indexes are rebuilt.

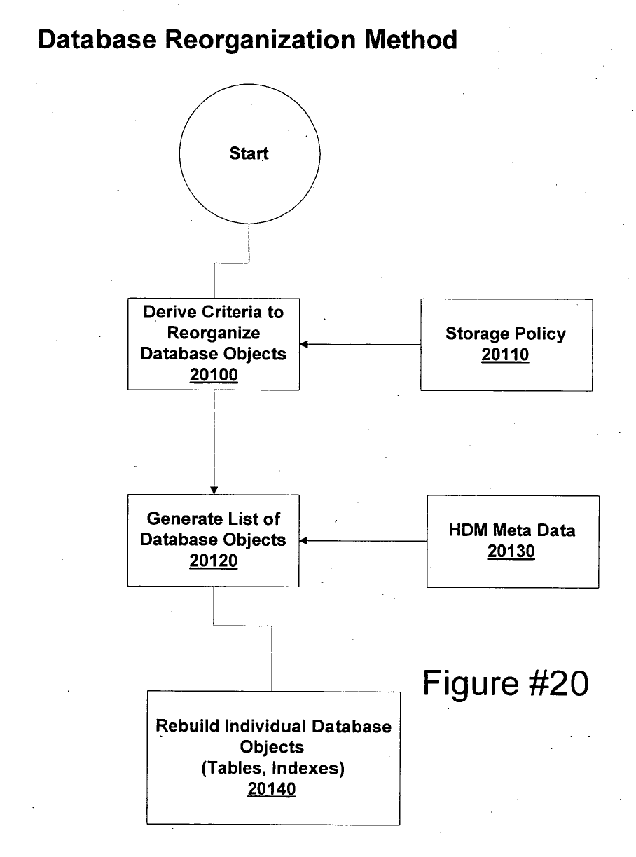

FIG. 21 illustrates the entire HDM system and architecture including the major components and interface points between them in accordance with the teachings of various embodiments of the present invention. In addition, FIG. 21 illustrates the examples of how and where the user can control the system.

The user interface 21100 allows the user to control the policy manager 21110 and the operation of the preview 21140. The policy manager 21110 is used for the data management policy 21120 and the storage policy 21130 which are used to generate the logical partitioning key 21150. The entity relationship discoverer 21160 is used with the data reorganizer 21180 and with the logical partitioning key 21150 for the partition manager 21170. The partition manager 21170 controls the legacy migrator 21200, the database subsetter 21210, the data mover 21220, the partition mover 21230 and the access layer/archiver 21240. These are used by the file manager 21250 to name, create, copy access and control the partitions found in the high-speed storage 21300, the medium speed storage 21310 and the low-speed storage 21320.

Next, some of the components of the present invention are further described, according to various embodiments of the invention.

In some embodiments, the logical partitioning key 21150 is one component of the present invention to be used as a basis for partitioning data within the database. As the user determines the parameters for a given application module to create the data class, the HDM architecture creates the unique logical partitioning key for a unique partition of the database to serve as a mapping agent between the parameters of the user and a physical column used for the database partition which implements the data class concept.

In some embodiments, the entity relationship discoverer 21180 is one component of the present invention configured for identifying referentially intact rows in related tables that constitute a business object or application module. The entity relationship discoverer obtains and provides the metadata of the HDM architecture and procedures that are used by other components of the system to implement the HDM architecture. In some embodiments, the entity relationship discoverer may be application module specific and is implemented for every business object or application model. The entity relationship discoverer goes beyond the data base dictionary in deriving the relationships. The data relationship discoverer could employ column matching, application reverse engineering, source code scanning, SQL tracing of the application, and manual steps to derive such information. The operation of the entity relationship discoverer may be part of the development cycle for each application module or support for a predetermined business model. The metadata is used at runtime to drive various aspects of the HDM architecture.

In some embodiments, another component of the HDM architecture is the data mover 21220 which is configured for converting tables related to each business object from a table type to a partition table type. The value of the default logical partitioning key at the start up has a partition value of zero. As the user processes additional business objects, new partitions using new logical partitioning keys are created in accordance with the data management and storage policies. The data mover moves rows which were obtained from applying the module logic into the target partition. The RDBMS is configured to move the row from the source to the target partition.

In some embodiments, another component of the present invention is a file manager 21250 that is configured for determining the file structure based on the policy of the HDM architecture. Typically, the file manager may determine the filename, the table space name, the file size and the physical media. The file manager generates metadata which is used by other components of the HDM architecture to create table spaces, create partitions, move partitions, and copies files for example by the subsetter. Furthermore, the file manager may determine the access mode such as compression, read-only, or read-write for table spaces having less active and historical data in accordance with the storage policy.

In some embodiments, another component is the data management policy 21120 which allows users to define the data classes to be maintained. The users may also define rules for each of the data classes as well as migration rules from one data class to another as the data progresses within its life cycle. The data class defined by this data management policy is used by the storage policy to map classes to the I/O subsystems available to the HDM architecture. Through the data management policy, the user can define system wide rules to be validated each time the HDM architecture is executed to prevent erroneous runs of the system. Furthermore, the users through the data management policy define parameters for each application module which the users desire to have maintained as well as rules for defining the data to be retained if a subsetted copy of the production database is created.

In some embodiments, another component of the present invention is a storage policy 21130. This policy is used by the HDM architecture to implement the data class definitions within the data management policy. With the storage policy, the administrator can map the different data classes defined by the actual users to the actual I/O available on the system. The administrator can map the data classes independently from the users as additional system resources become available without impacting users. The administrator can also define story related attributes for table spaces, data files, partitions, fragmentation and frequency of object reorganization to near optimize resource utilization.

In some embodiments, the data subsetter 21210 is another component of the present invention. The data subsetter is used to create a smaller or reduced in size copy of the production database for the active only transactions or any range of the data the user can specify. The data subsetter uses metadata from the data management policy and storage policy to create a database copy with a minimum number of file transfers. This provides an advantage of not copying the entire database which may be followed by the time consuming process of subsetting the database. With the subsetting of the present invention, the newly created database can be used for testing and development purposes when the entire footprint of the production database is not required.

In some embodiments, the access layer 21240 is another component of the present invention. When the HDM architecture is configured for archiving, the access layer is used to provide a transparent and secure access to the archived data. The data access rules corresponding to the access layer are defined by the data management policy, and a set of tables corresponding to the access layer is derived from the metadata of the HDM architecture. The super-user or administrator can define different rules for different users or groups of users as related to data classes or data ranges. This advantage enables the HDM architecture to provide multiple, dynamic and concurrent access to the same data but with multiple users without having to move data from the original table and to allow archived data to be modified by privileged users.

In some embodiments, the HDM engine is another component of the present invention. The HDM engine of the HDM architecture may be configured for defining, executing, managing, storing, and reporting instructions to implement the operations required to build the HDM system.

In some embodiments, the HDM migrator 21200 is another component of the HDM architecture of the present invention. The HDM migrator is used to migrate and convert legacy systems which have implemented a non-HDM architecture for archiving data to the HDM architecture.

In some embodiments, another component of the present invention is the storage re-organizer 21180 which is configured to derive the list of tables and indexes from the metadata of the HDM architecture to determine potential candidates for reorganization activities once the data mover completes a cycle of the HDM architecture. The rebuild activity which includes attributes and parameters are derived from the storage policy so that the storage reorganizer can operate without user intervention or an administrator.

In some embodiments, another component of the present invention is preview 21140. The preview component is configured to provide multiple levels of details for the user to determine a list of transactions for a given application module which are eligible for implementation of the data management policy. Additionally, preview provides estimates of storage impact for different data classes and provides estimates both on potential storage reclaimed and storage requirements.

In some embodiments, another component of the HDM architecture is the partition mover 21230. The partition mover determines the list of partitions and their corresponding indexes that are scheduled to be moved to another tier of storage or another level of storage class in accordance with the configuration of the storage policy. The partition mover implements the lifecycle management by moving data to the partition or appropriate storage area in accordance with the data class attributes. The partition moves data in bulk by issuing operations that move all records within a specific partition at once. These operations can be done online while the system is up and running and while users performing their own normal transactions. Subsequently, indexes related to these parathions may also managed and rebuilt online.

In some embodiments, the HDM architecture includes a HDM engine and configures physically partitioned or group related data into multiple entities of data classes which may be based on the time lifecycle of the data. These data classes include a set of attributes that can be mapped to the physical media residing in the I/O subsystem in order to manage the data efficiently. These data classes could also have set of attributes that determines secured data access at multiple levels, implementing data protection, provide auditing capabilities, appropriate data disposal to achieve regulatory compliance. These features allow the administrators to enhance the system performance, security, data protection, compliance while keeping cost at minimum. Once the data is separated into partitions based on lifecycle of the data, the administrator may allocate the high-speed I/O subsystem to the most active and recent transactions, and may allocate less active data and less recent data to medium speed and less expensive I/O subsystems and may allocate inactive data to inexpensive but slow I/O subsystems. The HDM architecture physically partitions data. This is an advantage over the relational database management systems RDBM which does not guarantee a particular physical distribution of data into the underlying file system.

In some embodiments, the HDM architecture includes tables which are related to a particular business object which is partitioned based upon a common logical partitioning key so that partitions of different tables can be managed using the data definition language DDL such as ‘truncate partition’, ‘drop partition’, ‘alter table’ and ‘exchange partition’ can be used without breaking the referential integrity of the application. These DDL operations may be used to perform work on bulk data. Since these DDL operations manipulate the meta data dictionary information and does not necessarily change the data itself, the HDM architecture uses this characteristic to provide scalable run-time performance and predictable results regardless of the amount data being managed.

In some embodiments, the logical partitioning key 21150 may include a single physical column or a multiple physical columns which is created by the hierarchal data management engine based on user configurations. The use of the logical partitioning key provides consistency across business objects or application modules so that the application modules can be uniformly treated by the HDM architecture. The HDM architecture can optionally include information such as a timestamp, group ID and business object ID to provide for auditing functionality and future enhancements. The storage management is substantially independent transparent to the application functionality. Business objects as discussed herein a referrer two rows of the table that constitute a business object such as sales order, purchase order, WIP job or AP invoice.

Several embodiments are specifically illustrated and/or described herein. However, it will be appreciated that modifications and variations are covered by the above teachings and within the scope of the appended claims without departing from the spirit and intended scope thereof. For example HDM could also be used to implement data classifications to implement the following features in addition to an efficient storage management: (1) Business object level access security which allows users with certain privileges to have access to certain types of data. This is accomplished by adding a “business_object_id” column, in addition to the LPK column, to all the tables that constitute a business object or application module. The business_object_id column will be used as a demoralized key that will have the high-level business object id, such as sales order number, populated in the required tables. This business object id is derived during the data movement process which forces a given business object to be moved into the appropriate partition. (2) Auditing features that allow the system to track changes or modifications once data has been classified under certain business rules. (3) An ability to implement effective data disposal capabilities at the partition or data class level. And, (4) improving performance scalability by distributing data in a more intelligent manner on the I/O subsystem.

The embodiments discussed herein are illustrative of the present invention. As these embodiments of the present invention are described with reference to illustrations, various modifications or adaptations of the methods and or specific structures described may become apparent to those skilled in the art. All such modifications, adaptations, or variations that rely upon the teachings of the present invention, and through which these teachings have advanced the art, are considered to be within the spirit and scope of the present invention. Hence, these descriptions and drawings should not be considered in a limiting sense, as it is understood that the present invention is in no way limited to only the embodiments illustrated.

What is claimed is:

1. A hierarchal data management system for a storage device, comprising:
an entity relationship discover to generate meta data from a business object;
a file manager to create a partition based on said metadata; and
a data mover to generate a logical partitioning key and to store the logical partitioning key in said metadata for said partition, said file manager including a data management policy to define a data class and a storage policy to map said data class to said storage device to form a partition table.

2. The hierarchal data management system of claim 1, further comprising a data mover configured to convert a table of said business object to a partition table corresponding to said partition.

3. The hierarchal data management system of claim 1, further comprising a data subsetter configured to generate a reduced in size copy of said partition table.

4. The hierarchal data management system of claim 1, wherein the data management policy includes transparent access and secure access to data and said secured access and said transparent access is managed by an access layer.

5. The hierarchal data management system of claim 1, further comprising a migrator configured to mitigate and convert a legacy system to the hierarchical data management system.

6. The hierarchal data management system of claim 1, further comprising a re-organizer configured to analyze said metadata and re-organized a portion of said metadata.

7. The hierarchal data management system of claim 1, further including a partition mover configured to move said partition to a different tier of said storage device.

8. The hierarchal data management system of claim 7, wherein said partition mover is configured to move said partition to a different level of said storage device in accordance with said storage policy.

9. The hierarchal data management system of claim 1, wherein said data class and storage policy are configured to map data to either the partition table or another partition table responsive to a date of the data.

10. The hierarchal data management system of claim 1, wherein said data class and storage policy are configured to map data to either the partition table or another partition table responsive to how frequently the data is accessed.

11. A method for forming a hierarchal data management system for a storage device, comprising the steps of:
generating meta data from a business object;
creating a partition based on said metadata;
generating a logical partitioning key and storing the logical partitioning key in said metadata for said partition;
forming a data management policy to define a data class; and
defining a storage policy to map said data class to said storage device to form a partition table.

12. The method of claim 11, further comprising converting a table of said business object to a partition table corresponding to said partition.

13. The method of claim 11, further comprising generating a reduced in size copy of said partition table.

14. The method of claim 11, further comprising obtaining transparent access and secure access to data and said secured access and said transparent access is managed by an access layer.

15. The method of claim 11, further comprising migrating and converting a legacy system to the hierarchical data management system.

16. The method of claim 11, further comprising analyzing said metadata and re-organizing a portion of said metadata.

17. The method of claim 11, further including moving said partition to a different tier of said storage device.

18. The method of claim 17, wherein said partition mover moves said partition to a different level of said storage device in accordance with said storage policy.

19. The method of claim 11, wherein the storage policy is configured to map data to different partition tables responsive to a date of the data.

20. A system comprising:
a first database partition stored on a first storage device and configured to store data, the first data being within a first date range;
a second database partition stored on a second storage device and configured to store second data, the second data being within a second date range, the first storage device having a faster physical access time than the second storage device, the second date range being prior to the first date range;
a global data table comprising the first database partition and the second database partition, the first database partition and the second database partition being transparent to a user;
partition meta data including a logical partitioning key configured for determining if data should be stored in alternatively the first database partition or the second database partition, the logical partition key being further configured for controlling the visibility of the first data and the second data to a user; and
a data management policy configured for using the first database partition and the second database partition to archive the second data without removing the second data from the global data table.
